(19) United States
(12) Patent Application Publication
(10) Pub. No.: US 2001/0012025 A1
(43) Pub. Date: Aug. 9, 2001

(54) DISPLAY SCROLLING SYSTEM USING POINTING DEVICE

(75) Inventors: DAVID JAMES WOJACZYNSKI, MISSION VIEJO, CA (US); CHARLES LEE, SIMI VALLEY, CA (US)

Correspondence Address: PILLSBURY MADISON & SUTRO, 72 SOUTH FIGUEROA, SUITE 1200, LOS ANGELES, CA, 900175443

(73) Assignee: TOSHIBA AMERICA INFORMATION SYSTEMS, INC.

(21) Appl. No.: 09/045,463

(22) Filed: Mar. 20, 1998

(51) Int. Cl. G09G 5/08

(52) U.S. Cl. 345/856

(57) ABSTRACT

A method of scrolling a display window on a computer system is provided. According to the method, movement of a pointing device and a request for pointer scrolling are detected. If pointer scrolling is requested and there is movement of the pointing device, the display window is scrolled. In a preferred embodiment, a request for automatic pointer scrolling is also detected. If automatic pointer scrolling is requested, the display window is repeatedly scrolled at predetermined intervals until automatic pointer scrolling is no longer requested. Additionally, a computer system is provided that includes a central processing unit (“CPU”), a display, a keyboard, and a pointing device. The pointing device normally controls movement of a cursor on the display. However, when a selected key of the keyboard is pressed and there is movement of the pointing device, the CPU executes instructions that cause the scrollable window to be scrolled in response to the movement of the pointing device.

### BACKGROUND

1. Field of the Invention

The present invention relates to a pointing device-based display scrolling system, and more specifically to a system using a pointing device to allow easy and efficient scrolling of the information displayed in a computer system.

2. Related Art

A typical conventional computer system executes an operating system (“OS”) and application software in a graphical user interface (“GUI”) environment. In the GUI environment, a user interacts with the computer system through a keyboard and a pointing device (e.g., a mouse, trackball, touchpad, or control stick). In particular, the pointing device is used to move a cursor to graphics elements on the display. The user may enter additional information through the keyboard and other button switches. To facilitate such joint control, the pointing device and selected buttons are positioned together in a separate device (e.g., in the standard mouse), or are put on the keyboard (e.g., in notebook computers).

The pointer and keyboard events occur in conjunction with “windows” of cursor-selectable graphics elements (i.e., “icons”) on the display of the computer system. A window may appear in the form of a desktop, a menu, a button, a scroll bar, or the like. A scrollable window has scroll bars that allow different portions of data to be selectively viewed within the limited size of the window frame. The portion of the data being displayed is synchronized with and controlled by the scroll bars. The OS software provides the core program code for the GUI, and essentially all application software supports conventional window scrolling with the standard pointing device and scroll bars. Such GUI interfaces are provided by the Mac™ OS of Apple Computer, Inc. (Cupertino, Calif.) and by the Windows™ family of operating systems of Microsoft Corporation (Redmond, Wash.).

More specifically, to scroll the display in conventional computer systems, a user may first use a standard mouse device to select a desired window. More specifically, the user moves the cursor over a window corresponding to a desired application and then clicks (i.e., activates) the mouse button to select the desired window. This causes the selected window to overlay other windows and graphics elements in its display area, as permitted by the computer system. After selecting the window, the user scrolls the display by moving the cursor to the scroll bar of the window and then clicking a scroll arrow or dragging the scroll thumb. Alternatively, the user can scroll the display using the keyboard. In particular, a specific sequence of keys is activated to select a window and then arrow keys are used (as scroll arrows) to scroll the display.

The conventional scrolling system described above has several drawbacks. First, the user must shift his attention to the scroll bar, and must precisely position the cursor within a relatively small region of the scroll bar in order to accomplish the desired scrolling. Additionally, the desired window may be partially hidden by another window. Therefore, the user must move the desired window or scroll the other window to gain access to the desired scroll arrow. Further, the user cannot manage the scroll speed or perform automatic scrolling, and instead must repetitively click the mouse button on the scroll arrow. While it is possible to hold down the mouse button on the scroll arrow, this causes the display to scroll uncontrollably at an unreasonably fast speed. The drawbacks described above also apply when conventional scrolling is performed using the keyboard. Further, when using the keyboard to effect scrolling, the user may have to constantly switch between the mouse and the keyboard.

To overcome some of these drawbacks, there has recently been developed a scrolling system using a specialized mouse that includes a wheel device (“mouse wheel”). The specialized mouse is basically a standard two-button mouse device with a small wheel provided on top between the two standard mouse buttons. The user can rotate the mouse wheel about a fixed axis, click the mouse wheel like a button, or rotate the mouse wheel while applying downward pressure. Mouse wheel software is incorporated into the operating system so that mouse wheel movements are communicated to the application in the selected window, and the application typically responds to mouse wheel rotation by scrolling the display window. Additionally, the user may press down on the mouse wheel to trigger automatic scrolling, with the direction and speed controlled by subsequent wheel rotation or pointer motion. Thus, the mouse wheel scrolling system overcomes some of the drawbacks associated with scroll bars by avoiding the need to use the scroll bars to effect display scrolling. However, because each application must be specifically written to recognize and properly respond to mouse wheel movements, the scroll bars must still be used to scroll the display windows of older applications in the conventional manner.

In order to allow applications that do not include support for the new mouse wheel to respond to mouse wheel movements, it has been proposed that a utility program can be used to convert mouse wheel movements into conventional scrolling actions. More specifically, a typical GUI software architecture may employ a utility program to tap into the standard software communication channel to intercept and translate mouse wheel movements into standard scrolling actions for non-supporting applications. Such a utility program for use with a computer system running the Windows™ operating system (sold by Microsoft Corporation) has been written.

This program requires the user to designate beforehand any applications for which mouse wheel movement translation is desired. Then, whenever mouse wheel movement occurs, the utility program recalls the selected application list and, if the current application is on the list, translates the mouse wheel movement into conventional scrolling actions. While such a utility program allows more applications to respond to mouse wheel movements, additional hardware (i.e., a specialized mouse with a mouse wheel) is required. Besides adding expense to the system, the requirement of additional hardware makes the mouse wheel scrolling system an inconvenience to using notebook computers that incorporate a conventional built-in pointing device. Additionally, the program is loaded into the address space of each application and intercepts actions other than mouse wheel rotations, thereby adding overhead to the operating system.

### SUMMARY OF THE INVENTION

In view of these drawbacks, it is an object of the present invention to remove the above-mentioned drawbacks and to provide a system that allows easy and efficient display scrolling without the need for additional hardware. The display scrolling system allows a conventional pointing device to scroll a window without using scroll bars. When certain keyboard keys (e.g., “Ctrl”) are pressed, the system causes pointer movements to scroll the window beneath the cursor, instead of moving the cursor. Additionally, when other keys (e.g., “Ctrl”+“Alt”) are pressed, automatic scrolling is activated to cause the display window to continue to scroll without further pointer action. When the activating key is released, the system discontinues display scrolling and returns to controlling cursor movement in the normal manner. Thus, the display scrolling system of the present invention provides the convenience of a mouse wheel scrolling system without requiring any new hardware. This, in turn, allows the display scrolling system to be used in notebook computers having a built-in pointing device.

According to a first embodiment of the present invention, a method of scrolling a display window on a computer system is provided. The method includes detecting movement of a pointing device and a request for pointer scrolling. If pointer scrolling is requested and there is movement of the pointing device, the display window is scrolled. In one preferred embodiment, the method also detects a request for automatic pointer scrolling. If automatic pointer scrolling is requested, the display window is repeatedly scrolled at predetermined intervals until automatic pointer scrolling is no longer requested.

According to a second embodiment of the present invention, a computer system is provided that includes a central processing unit (“CPU”), a display, a keyboard, and a pointing device. The pointing device normally controls movement of a cursor on the display. However, when a selected key of the keyboard is pressed and there is movement of the pointing device, the CPU executes instructions that cause the scrollable window to be scrolled in response to the movement of the pointing device. In one preferred embodiment, when another selected key of the keyboard is pressed, the CPU executes instructions that cause repeated scrolling the display window at predetermined intervals from an initial pointing device movement until the other selected key is released.

Other objects, features, and advantages of the present invention will become apparent from the following detailed description. It should be understood, however, that the detailed description and specific examples, while indicating preferred embodiments of the invention, are given by way of illustration only and various modifications may naturally be performed without deviating from the present invention.

### BRIEF DESCRIPTION OF THE DRAWINGS

FIG. 1 is a flow chart for a display scrolling system according to a preferred embodiment of the present invention;

FIG. 2 is a block diagram showing data flow in a computer system that includes the display scrolling system according to the present invention;

FIG. 3 is a flow diagram illustrating the interaction of a virtual device driver and a pointing device application according to an embodiment of the present invention; and

FIG. 4 is a detailed flow diagram illustrating one embodiment of the display scrolling system software of the present invention.

### DETAILED DESCRIPTION OF PREFERRED EMBODIMENTS

Preferred embodiments of the present invention will be described in detail herein below with reference to the attached drawings.

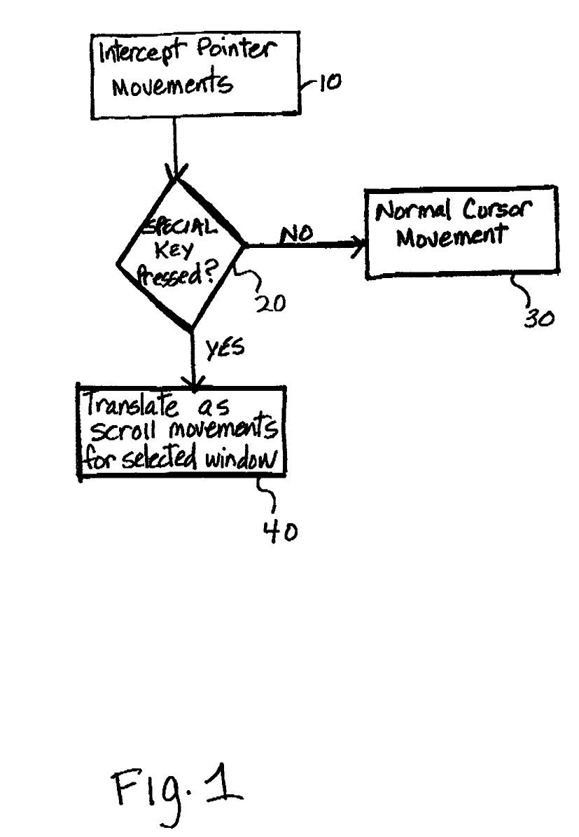

FIG. 1 shows a flow chart for a display scrolling system according to a preferred embodiment of the present invention. In the preferred embodiment of the present invention, a computer system is provided that executes operating system (“OS”) and application software in a graphical user interface (“GUI”) environment. A user controls the computer system using a keyboard and a pointing device (e.g., a mouse, trackball, touchpad, or control stick such as the AccuPoint® control device of Toshiba Corporation) that operate in conjunction with “windows” on a display. One of the windows on the display can be “selected” by moving the cursor to a portion of the window and then clicking the mouse button, or by entering special key sequences on the keyboard. The OS software provides the core program code for the GUI.

According to the preferred embodiment, a software utility taps into the standard software communication channel to intercept movements of the pointing device at step 10, as shown in FIG. 1. When pointer movement is detected, the utility checks to see if a special activation key is being pressed at step 20. If the key is being pressed, the pointer movement is translated into standard scrolling actions and sent to the application corresponding to the selected window at step 40. On the other hand, at step 30, the pointer movement is not translated when the special key is not being pressed. In this manner, the display scrolling system of the present invention enables the standard pointing device to be used to selectively scroll the display window for easy and efficient scrolling without the need for new or additional hardware.

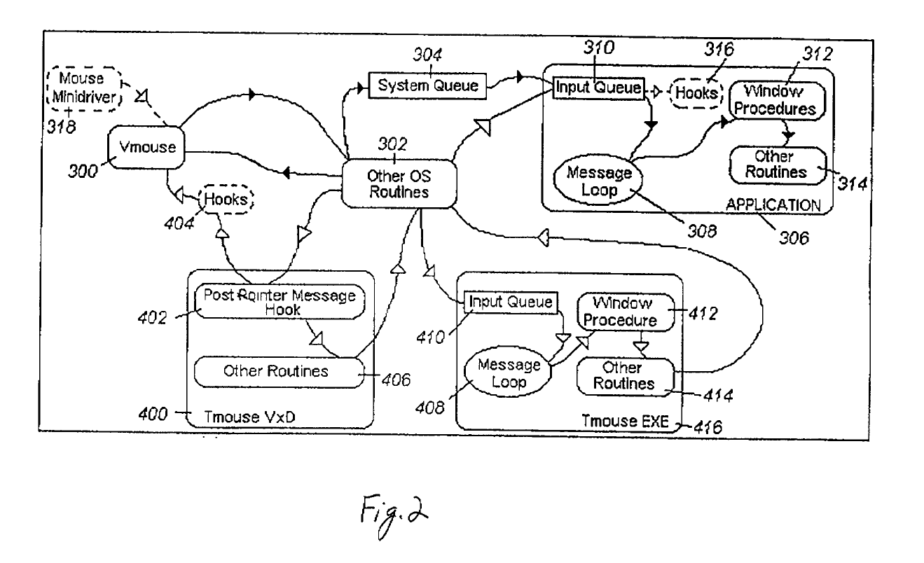

FIG. 2 shows the data flow in a computer system that includes a display scrolling system in accordance with the preferred embodiment of the present invention. In the computer system, the application software serves as the user interface and requests that the OS performs specific tasks on behalf of the user. The OS software manages the computing environment, interacts with the hardware, and provides application support routines. Standardized message packets allow the OS and application software to communicate with one another. For example, the Windows 95 OS defines window messages (“WM”) that are used to communicate the characteristics of application windows and the activities in application windows. Each window message consists of a standardized message number and two parameters. Pointer motion is communicated through message number (in mnemonic form) “WM_MOUSEMOVE” with the cursor coordinates encoded in the parameters, and vertical scrolling is communicated through message number “WM₁₃ VSCROLL” with the direction and magnitude contained in the parameters. The recipient window for a window message is designated by a “window handle,” which is a unique identifier assigned by the OS when the window was created.

In FIG. 2, the standard sequence for processing pointer action is shown by the solid arrow lines. The pointing device encodes pointer deviation and button state into data bytes and initiates hardware interrupts. These interrupts are serviced by Vmouse 300, which is a virtual device driver (“VxD”) that is part of the OS software. The Vmouse driver converts the raw data into cursor coordinates and button state, and then uses an OS routine 302 to place the pointer status into the first-in-first-out (“FIFO”) system queue 304. The system queue is used to communicate information regarding pointer activity, keyboard activity, and other hardware events to running applications.

Each entry in the system queue is translated into window messages by the OS routines 302. The OS routines then identify the recipient application 306 by searching the list of windows for the one lying just beneath the cursor or the window that has captured (i.e., requested all) input focus. The translated window messages are placed in the FIFO input queue 310 of the recipient application 306. The message processing loop 308 of the application 306 intermittently retrieves window messages from its input queue 310, and dispatches them to the appropriate window procedure 312. The window procedure 312 decodes the window message and then executes the appropriate application code 314 in response to the message.

Applications or virtual drivers can use OS routines such as “PostMessage” or “SHELL_PostMessage” to bypass the system queue and place window messages directly into an application's input queue. These routines require the desired window message and the window handle of the recipient to be provided as parameters. These and other OS routines are described in detail in the Microsoft Platform Software Development Kit (“SDK”) and Microsoft Windows 95 Device Driver Kit (“DDK”), which are herein incorporated by reference.

Further, “hook routines” can be used to tap into the message processing stream of the OS. As shown by the dashed lines in FIG. 2, the OS software 302 can call hook routines 316 and 404 during various stages of message processing. The OS preferably executes code in the latest hook 402 for a stage and can pass the desired data as part of the parameters. The called hook may execute other hooks before resuming the normal OS processing stages, or may pass the data to other routines. Thus, special OS routines and hook routines can be used to tap into the message processing stream of the OS.

A preferred embodiment of the present invention uses a software utility to convert pointer movements into conventional scrolling actions when the user presses special keyboard keys, as explained above. The utility taps into the pointer message processing stream using its own Tmouse virtual device driver 400, which contains a VMD Post Pointer Message (“PPM”) hook routine 402. Because the Tmouse virtual driver is not a “minidriver,” it can coexist with any existing pointer minidriver. The routines of the Tmouse driver 400 install and uninstall the hook routine 402 in accordance with the DDK. Additionally, other routines 406 pass modified pointer data from the PPM hook 402 to other software in order to bypass the standard message routes. The PPM hook 402 is executed when the OS software 302 is about to pass pointer data back to the Vmouse driver 300 for final processing. The PPM routine 402 determines whether the pointer data should be returned to the Vmouse driver 300 as scrolling data or normal pointer data. The data passed to the PPM routine 402 includes the pointer deviation, button state, and reference to a Tmouse Data Structure (TDS), which is a set of parameters previously set by the Tmouse driver 400 to hold information related to scrolling and other mouse information.

According to an embodiment, pointer initiated scrolling is selected by depression of the “Ctrl” key and pointer initiated automatic scrolling is selected by a depression of both the “Ctrl” and “Alt” keys. However, since it is common for an operating system or applications programs to use the “Ctrl” key or “Alt” key as modifier keys for pointer action, it may be necessary to activate pointer initiated scrolling with a depression of both the “Ctrl” and “Alt” keys. The automatic pointer initiated scrolling may then be removed or activated with some other keystroke combination.

The Tmouse software preferably supports multiple pointing devices operating simultaneously, with distinct settings corresponding to each of the pointing devices. The Tmouse software preferably maintains a data structure for each such device and implements a hook at the driver level, at the post pointer message hook process 402 for example, and employs logic to tag data from the pointing devices. Accordingly, when the “Ctrl” key is depressed, for example, pointer scrolling can result from the motion of the built-in pointing device of a notebook computer, but not from the motion of an externally coupled pointing device.

According to an embodiment, the GUI allows a user to enable (through a Windows “Control Panel” applet, for example) the conversion of cursor movement commands from specific attached devices (and their associated software drivers) into scrolling commands. The Tmouse driver 400, maintaining a data structure for each instance of a software driver corresponding to a pointer device, receives the cursor control commands from each such instance of a software driver. Inputs from the GUI received at the Tmouse driver 400, corresponding to a particular attached pointing device and corresponding instance of a software driver, enable or disable the selectable conversion of cursor movement commands into scrolling commands. Thus, according to an embodiment, the conversion of cursor movement commands from a particular pointing device/software driver instance requires enabling such from the GUI inputs and depression of the proper key on the keyboard.

FIG. 2 illustrates an embodiment in which the keypress to activate scrolling is detected at the driver level and intercepted pointer motion is sent to the Tmouse application 416. This requires one-way communication from the Tmouse driver 400 to the Tmouse application 416. This is feasible in an operating system such as Windows 95 in which the operating system makes essential routines available to the Tmouse driver 400 and Tmouse application 416, and these processes can interact more freely. In embodiments with more restrictive operating systems such as Windows NT however, keyboard events may be detected at the application level and the application level process may then interrogate the driver level process as to the detection of any pointer events. Such logic requires bi-directional communication between the application level and driver level processes.

According to an embodiment of the present invention, the operating system supports at least three classes of windows having an image which is vertically scrollable. A first class of window displays a scroll bar for receiving user inputs to scroll the main portion of the image such as an edit box or list box. A second class of window does not display a scroll bar but is nevertheless capable of receiving scroll messages for scrolling the image. A third class of window is vertically scrollable only in response to keyboard commands such as up arrow or down arrow or to mouse-wheel commands, as in the case of an Internet Explorer_Server window.

The first class of window may receive scrolling signals in response to either of two different events. The first event is a cursor clicking on and dragging portions of the scroll bar to cause a corresponding scroll of the display portion of the window in a conventional fashion. The second event is a detected movement of a pointing device while a certain combination of keys on the keyboard are depressed. Either of these types of events result in inputs to the input queue 310 to provide a scrolling message to the application 306.

The second class of window does not have a displayed scroll bar and, therefore, is not capable of receiving scrolling messages which are initiated by clicking on and dragging a portion of a visible scroll bar. Such a window may nevertheless be a part of a “parent” window which may also include scrolling processes. These scrolling processes may have handles which are separate from the display window and yet send scrolling messages to the parent window. The parent window may then control the scrolling of the display window in response to the scrolling messages from scrolling processes.

Scrolling in the second class of window may thus occur in response to detected movement of the pointing device while the cursor is in the display window and a certain combination of keys are depressed. The Tmouse routines 414 preferably obtain the handle of the parent window. The routines 414 then preferably search for any other scrolling processes within the parent window. When there is more than one scrolling process, the routines 414 preferably choose a scrolling process based upon its conformity with the GUI layout. For example, scrolling processes may be associated with locations on the GUI and the chosen process may be associated with a screen location which is closest to the cursor. The routines 414 then provide scroll messages as inputs to the input queue 310 based upon the chosen scrolling process.

The third class of window is scrollable in response to key strokes, independent of inputs from the pointing device. The Tmouse application 416 receives inputs indicating the location of the cursor, from which the handle and class of the display window can be determined. For a window of the third class, the Tmouse application 416 then provides keystroke inputs, such as those of an up-arrow or a down-arrow, to the OS routines 302 to pass to the input queue 310. That display window of the third class will then scroll in response to the incoming keystroke messages.

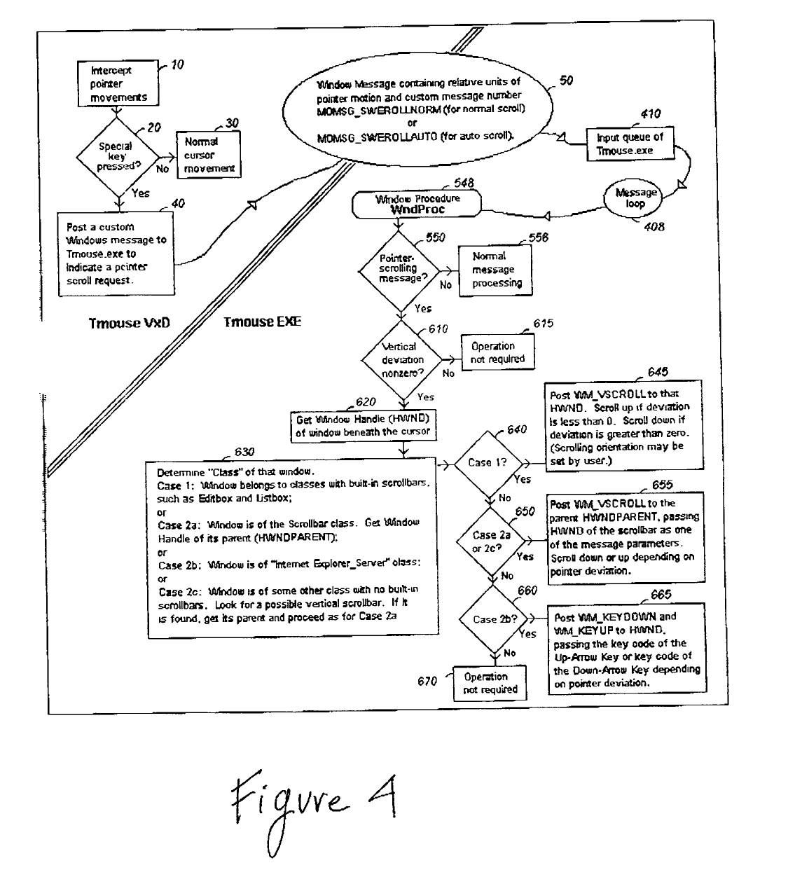

FIG. 4 shows a flow diagram illustrating the interactions between the Tmouse driver 400 and the Tmouse application 416 according to an embodiment. The Tmouse driver 400 intercepts pointer movements at block 10 and determines whether any of the special keys are pressed at step 20. If no special key is pressed, the pointer movements are to be interpreted as normal cursor movements at step 30. Otherwise, if the special keys are pressed, the Tmouse driver 400 posts a custom windows message to the Tmouse application 416 to indicate a pointer scroll request at step 40.

This message to the Tmouse application 416 includes units of relative pointer motion and one of two different custom message numbers. These custom message numbers indicate either normal pointer scrolling or automatic pointer scrolling. After this message is loaded to the input queue 410, the Tmouse application 416 interprets the incoming message as requesting pointer scrolling at step 550, and then determines whether there is any associated vertical deviation at step 610. Upon determining that the incoming message is requesting pointer scrolling and that there is vertical deviation as represented by the units of relative pointer motion, the Tmouse application 416 obtains the handle of the window beneath the cursor. Based upon this handle, the Tmouse application may associate the particular window with one of the several window classes.

Block 630 illustrates this process of associating the particular window with one of the several window classes. Here, the window may belong to a class with built-in scroll bars (such as an edit box or list box) in a case 1, or the window may be a scroll bar itself shown at case 2a. Case 2b is a situation where the window is of the Internet Explorer_Server class, and case 2c is the case where the window is of a class having no built-in scroll bar but having an associated parent window which includes scrolling processes.

In the case when the window belongs to a class with built-in scroll bars, the scroll message is posted to the window application to effectuate the scrolling. In the case where the window is either a scroll bar or a window with no visible scroll bar, a scrolling message is posted to the handle of a parent window process as indicated at step 655. In the case when the window is of the Internet Explorer_Server class, keystroke messages are posted to the application to cause the scrolling of the display as shown at step 665.

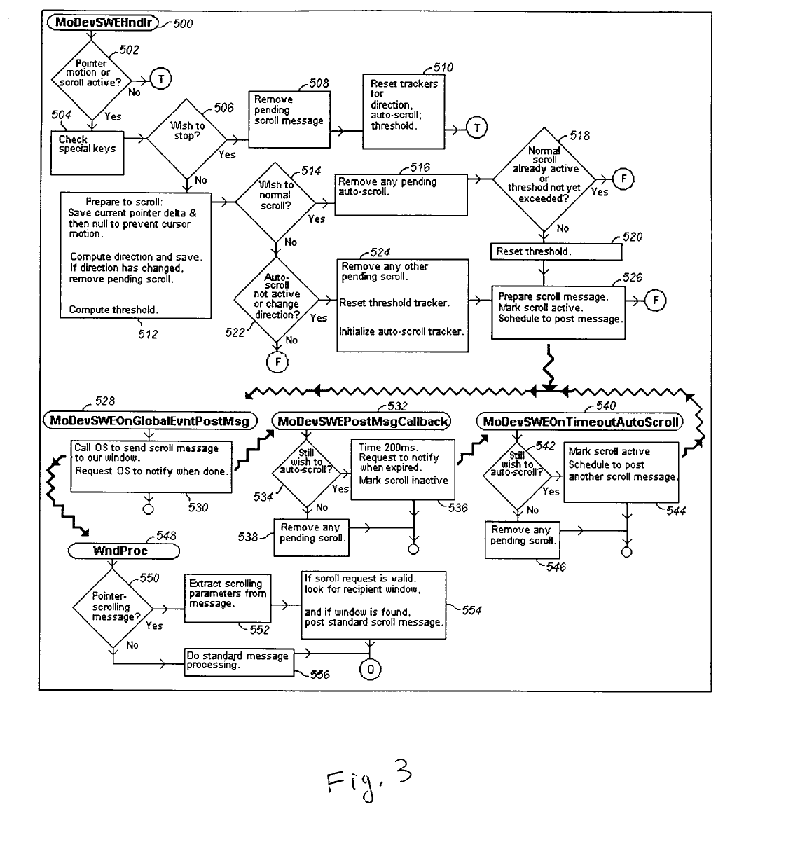

FIG. 3 shows the subroutine MoDevSWEHndlr 500 that the PPM routine uses to process the input data consisting of pointer deviation, button state, and TDS. If there has not been any pointer movement and there was no previous pointer scrolling (i.e., pointer scrolling is not presently active), then a value of TRUE is returned and mouse data is passed unchanged into the normal processing stream 502. On the other hand, if there was pointer movement or scrolling is active, the subroutine uses OS software to check the states of the “Ctrl” and “Alt” keys to determine if pointer scrolling is being requested at step 504. (In this embodiment, Ctrl is used as the activation key and Alt as the automatic scrolling key.) Step 506 determines whether the “Ctrl” key is being released. If so, then any existing pointer scrolling is canceled at step 508, values in the TDS for tracking pointer scrolling are reset at step 510, and the mouse data is passed unchanged back to the normal processing stream.

Alternatively, if it is determined that a special key is being pressed, the subroutine nulls the pointer deviation to prevent cursor movement when pointer scrolling is active, and checks for a change in scrolling direction at step 512. Additionally, the subroutines determine whether the accumulated pointer deviation (since the last pointer scrolling action) has exceeded a threshold. This prerequisite preferably prevents excessive pointer scrolling requests from being sent.

Step 514 determines whether normal scrolling is being requested. If so, any existing automatic scrolling is stopped at step 516. Then, if the pointer deviation threshold has been reached and pointer scrolling is not in progress as determined at step 518, the threshold counter is reset at step 520 and a pointer scrolling message is prepared at step 526. Otherwise, the PPM subroutine ends without passing any data to the Vmouse driver so as to “pause” after each pointer scrolling message. This causes the window to scroll at a reasonable rate proportional to pointer deviation when the user exerts persistent pointer motion, allowing the user to properly view the items that are scrolled. In the preferred embodiment, the threshold is set at +/−40 units.

If automatic scrolling is being requested, then the PPM subroutine determines whether automatic scrolling has not yet started or if scrolling direction is being changed at step 522. If either of these conditions is met, the subroutine stops any existing scrolling at step 524 and then prepares a new pointer scrolling message at step 526. Then, to effect automatic scrolling, additional pointer scrolling messages are prepared and transmitted at regular intervals without the need for any further pointer deviation. To allow such action, the scrolling direction (as given by the sign of the initial pointer deviation) is saved at step 512.

In accordance with the DDK, the prepared pointer scrolling messages are posted by a posting routine MoDevSWEOnGlobalEvntPostMsg 528, which is scheduled for execution by the OS at step 526. (In FIG. 3, the zigzag arrow lines indicate that the OS has been requested to execute the subsequent routine.) The pointer scrolling message is posted at step 530 and then a request is made to execute a feedback routine MoDevSWEPostMsgCallback 532 in the Tmouse driver. Feedback is needed in order to perform automatic scrolling and to reset scrolling parameters after normal scrolling.

In particular, if the special keys indicate that automatic scrolling is still being requested, as determined at step 534, the feedback routine requests that the OS time a predetermined “delay” interval (e.g., 200 ms), and then call an autoscroll routine MoDevSWEOnTimeoutAutoScroll 540 in the Tmouse driver. After verifying that automatic scrolling is still being requested at step 542, the autoscroll routine repeats the cycle by scheduling the posting routine 528 so as to post another pointer scrolling message. Thus, a delay of about 200 ms is introduced between automatic pointer scrolling messages. If either the feedback routine or autoscroll routine determines that the special keys are not being pressed, automatic scrolling is stopped at steps 538 and 546. In a preferred embodiment, the user may choose the delay duration which will set the scroll speed of the display window during automatic scrolling.

The pointer-scrolling message prepared by the PPM subroutine consists of the scrolling type (i.e., normal or automatic) and the pointer deviation. Instead of moving the cursor, the PPM subroutine uses pointer deviation to determine the scrolling magnitude and direction. In the preferred embodiment, the sign of the vertical deviation may be changed according to user preference so that a positive deviation causes either the window content to be scrolled up or down. Each pointer-scrolling message is posted to the input queue 410 of an application file, Tmouse EXE 416, as shown in FIG. 2. The Tmouse application runs in an invisible window whose handle is made available to the Tmouse driver 400 when the application is loaded. (The invisible window causes the Tmouse application to be hidden from the user.) The message loop 408 of the application passes posted pointer scrolling messages to the window procedure 412 of the invisible window.

The window procedure 412 and other related routines 414 are shown in FIGS. 3 and 4 as a single window routine WndProc 548, which accepts both pointer scrolling messages and standard messages. When a pointer scrolling message is received, as determined at step 550, the scrolling magnitude and direction are extracted at step 552, and the handle of the window lying just beneath the cursor is obtained at step 554. Then, standard vertical scroll bar (WM_VSCROLL) or keystroke (WM-KEYDOWN or WM-KEYUP) messages are posted to the input queue of the application running in the recipient window. These last two steps have been described in more detail in relation to FIG. 4. In this manner, pointer messages are converted to scrolling messages to enable a typical pointing device to cause a display window to scroll, instead of moving the cursor.

As previously explained, the present invention provides a system that allows easy and efficient display scrolling without the need for additional hardware. When certain keyboard keys are pressed, movements of a conventional pointing device cause the window beneath the cursor to be scrolled. Further, automatic scrolling can be activated to cause the display window to continue to scroll without further pointer action. Thus, the display scrolling system of the present invention provides the convenience of a mouse wheel scrolling system without requiring any new hardware.

In the preferred embodiment, mouse actions are monitored and keyboard activities are checked as needed. This system has less impact on system performance than the mouse wheel movement conversion program mentioned above. Additionally, because embodiments of the present invention use special keys to enable pointer scrolling at any time, the user does not need to specify beforehand the applications that require translation. Further, the preferred embodiment allows the user to scroll the contents of a background window while keeping the active window in focus. One embodiment of the system is written in the C, C++, and Intel Assembly languages and created with the following software development tools: VtoolsD for Windows 95, Microsoft MASM, Microsoft Developer Studio, Microsoft Platform Software Development Kit (SDK) and Microsoft Windows 95 Device Driver Kit (DDK). The attached appendix contains the code for relevant portions of the Tmouse virtual device driver 400 and the application Tmouse EXE 416 in one preferred embodiment.

The embodiments of the present invention described above relate to systems running the Windows 95 OS. However, the system could be adapted to run in conjunction with other operating systems. Additionally, other design choices, such as the computer system's architecture, the type of pointing device used, the special keys used to activate the system, and the features and additional capabilities of the driver and application programs could easily be adapted. Furthermore, embodiments of the present invention may not include all of the features described above. For example, automatic scrolling and user preferences may not be available in all embodiments.

While there has been illustrated and described what are presently considered to be the preferred embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. In a computer system including a display, a host unit, at least one pointing device in communication with the display and the host to provide user inputs to the host unit for movement of a cursor in the display, the host unit having a software driver for processing inputs from the at least one pointing device, the host unit being capable of executing at least one software application which corresponds to at least one scrollable image in the display as part of a graphical user interface, the improvement including:
logic for associating the pointing device with the software application, the software application corresponding with the scrollable image in the display;
logic for receiving data from the software driver which is representative of a command from the pointing device to move the cursor in the display; and
logic for selectively scrolling the image in the display in response to the received data representative of a command to move the cursor in the display instead of moving the cursor.

2. The computer system of claim 1, wherein the computer system further includes a keyboard and the improvement further includes logic for detecting a keystroke to enable the logic for scrolling the image in the display in response to the data representative of the command to move the cursor in the display.

3. The computer system of claim 1, wherein the at least one pointing device includes one of a mouse, a trackball, a touchpad and a control stick.

4. The computer system of claim 1, wherein the logic for selectively scrolling the display further includes:
logic for converting commands to move the cursor into commands for scrolling the image; and
logic for transmitting the commands for scrolling the image to the software application corresponding with the image.

5. The computer system of claim 1, wherein the improvement further includes:
logic for detecting a continuous user request for automatic scrolling of the image;
logic for commencing a repeated scrolling of the image at set intervals in response to the request for automatic scrolling and in response to receipt of the data representative of the command to move the cursor in the display;
logic for sustaining the scrolling of the image at set intervals in response to the continuous user request for automatic scrolling independent of any additional data representative of commands to move the cursor; and
logic for terminating the repeated scrolling of the image when the request for automatic scrolling terminates.

6. The computer system of claim 1, wherein the computer system includes a plurality of pointing devices and the host unit includes an instance of a software driver corresponding to each of the plurality of pointing devices, and wherein the improvement further includes:
logic for selecting one of the plurality of pointing devices to provide scrolling commands in response to cursor movement commands;
logic for associating the instance of the software driver corresponding with the selected pointing device with the logic for selectively scrolling the display; and
logic for converting cursor movement commands from the instance of the software driver corresponding to the selected pointer device into scrolling commands.

7. The computer system of claim 1, wherein the logic for associating the pointing device with the software application corresponding with the scrollable image associates the pointing device based upon a location of the cursor in the display.

8. The computer system of claim 6, wherein the improvement further includes logic for associating cursor movement commands with specific ones of the plurality of pointing devices, and wherein the logic for selecting one of the plurality of pointing devices includes logic responsive to inputs from a graphical user interface for enabling the conversion of cursor movement commands associated with the selected pointing device into scrolling commands.

9. A method for scrolling an image in a display of a computer system, the computer system including a host unit, at least one pointing device in communication with the display and the host to provide user inputs to the host unit for movement of a cursor in the display, the host unit having a software driver for processing inputs from the at least one pointing device, the host unit being capable of executing software applications which correspond to scrollable images in the display, the method comprising:
associating the pointing device with a software application, the software application with a scrollable image in the display;
receiving data from the software driver which is representative of a command from the pointing device to move the cursor in the display; and
selectively scrolling the image in the display in response to the received data representative of the command to move the cursor in the display instead of moving the cursor.

10. The method of claim 9, the method further including detecting a keystroke from a keyboard to enable scrolling of the image in the display in response to the data representative of the command to move the cursor in the display.

11. The method of claim 9, the method further including providing the at least one pointing device as one of a mouse, a trackball, a touchpad and a control stick.

12. The method of claim 9, the method further including:
converting commands to move the cursor into commands for scrolling the image; and
transmitting the commands for scrolling the image to the associated software application.

13. The method of claim 9, the method further including:
detecting a continuous user request for automatic scrolling of the image;
commencing a repeated scrolling of the image at set intervals in response to the request for automatic scrolling and in response to receipt of the data representative of the command to move the cursor in the display;
sustaining the scrolling of the image at set intervals in response to the continuous user request for automatic scrolling independent of any additional data representative of commands to move the cursor; and
terminating the repeated scrolling of the image when the request for automatic scrolling terminates.

14. The method of claim 9, wherein the computer system includes a plurality of pointing devices, and the method further includes:
associating each of the pointing devices with an instance of a software driver;
selecting one of the plurality of pointing devices to provide scrolling commands in response to cursor movement commands;
associating the instance of the software driver of the selected pointing device with the logic for selectively scrolling the display; and
converting cursor movement commands from the instance of the software driver of the selected pointer device into scrolling commands.

15. The method of claim 9, the method further including associating the pointing device with a software application corresponding with a scrollable image based upon a location of the cursor in the display.

16. The method of claim 14, the method further including:
associating cursor movement commands with specific ones of the plurality of pointing devices; and
enabling the conversion of cursor movement commands associated with the selected pointing device into scrolling commands in response to inputs from a graphical user interface.

17. A computer software program which is implementable in a computer system including a display, a pointing device, and a host unit, the host unit having at least one software application and a software driver associated with the pointing device, the computer software program including:
logic for associating the pointing device with the software application, the software application corresponding with a scrollable image in the display;
logic for receiving data from the software driver associated with the pointing device which is representative of a command from the pointing device to move a cursor in the display; and
logic for selectively causing the image in the display to be scrolled in response to the received data representative of the command to move the cursor in the display instead of moving the cursor.

18. The computer software program of claim 17, wherein the computer software program further includes logic for detecting a keystroke from a keyboard to enable the image to be scrolled in the display in response to the data representative of the command to move the cursor in the display.

19. The computer software program of claim 17, wherein the computer software program is capable of receiving the data representative of the cursor movement command generated in response to movement of one of a mouse, a trackball, a touchpad and a control stick.

20. The computer software program of claim 17, wherein the logic for selectively scrolling the image further includes:
logic for converting commands to move the cursor into commands for scrolling the image; and
logic for transmitting the scrolling commands to the software application corresponding with the image.

21. The computer software program of claim 17, the computer software program further including:
logic for detecting a continuous user request for automatic scrolling of the image;
logic for commencing a repeated scrolling of the image at set intervals in response to the request for automatic scrolling and in response to receipt of the data representative of the command to move the cursor in the display;
logic for sustaining the scrolling of the image at set intervals in response to the continuous user request for automatic scrolling independent of any additional data representative of commands to move the cursor; and
logic for terminating the repeated scrolling of the image when the request for automatic scrolling terminates.

22. The computer software program of claim 17, the computer software program further including:
logic for selecting one of a plurality of pointing devices to initiate scrolling of the image;
logic for associating an instance of the software driver corresponding with the selected pointing device with the logic for selectively causing the image to be scrolled; and
logic for converting cursor movement commands from the instance of the software driver corresponding to the selected pointer device into commands for scrolling the image.

23. The computer software program of claim 17, wherein the logic for associating the pointing device with an application having a scrollable image associates the pointing device based upon a location of the cursor in the display.

24. The computer software program of claim 22, wherein the improvement further includes logic for associating cursor movement commands with specific ones of the plurality of pointing devices, and wherein the logic for selecting one of the plurality of pointing devices includes logic responsive to inputs from a graphical user interface for enabling the conversion of cursor movement commands associated with the selected pointing device into scrolling commands.

25. A system for scrolling an image in a display of a computer system, the computer system being capable of executing at least one software application, the system comprising:
at least one pointing device;
a software driver corresponding with the pointing device to provide cursor movement commands in response to movement of the pointing device;
logic for associating the pointing device with the software application, the software application corresponding with a scrollable image in the display;
logic for receiving data from the software driver which is representative of a command from the pointing device to move the cursor in the display; and
logic for selectively scrolling the image in the display in response to the received data representative of a command to move the cursor in the display instead of moving the cursor.

26. The system of claim 25, the sytem further including logic for detecting a keystroke on a keyboard to enable the logic for scrolling the image in the display in response to the data representative of the command to move the cursor in the display.

27. The system of claim 25, wherein the at least one pointing device includes one of a mouse, a trackball, a touchpad and a control stick.

28. The system of claim 25, wherein the logic for selectively scrolling the display further includes:
logic for converting commands to move the cursor into commands for scrolling the image; and
logic for transmitting the commands for scrolling the image to the software application corresponding with the image.

29. The system of claim 25, wherein the improvement further includes:
logic for detecting a continuous user request for automatic scrolling of the image;
logic for commencing a repeated scrolling of the image at set intervals in response to the request for automatic scrolling and in response to receipt of the data representative of the command to move the cursor in the display;
logic for sustaining the scrolling of the image at set intervals in response to the continuous user request for automatic scrolling independent of any additional data representative of commands to move the cursor; and
logic for terminating the repeated scrolling of the image when the request for automatic scrolling terminates.

30. The system of claim 25, wherein the computer system includes a plurality of pointing devices and the host unit includes an instance of a software driver corresponding to each of the plurality of pointing devices, and wherein the improvement further includes:
logic for selecting one of the plurality of pointing devices to provide scrolling commands in response to cursor movement commands;
logic for associating the instance of the software driver corresponding with the selected pointing device with the logic for selectively scrolling the display; and
logic for converting cursor movement commands from the instance of the software driver corresponding to the selected pointer device into scrolling commands.

31. The system of claim 25, wherein the logic for associating the pointing device with the software application corresponding with the scrollable image associates the pointing device based upon a location of the cursor in the display.

32. The system of claim 30, the system further including logic for associating cursor movement commands with specific ones of the plurality of pointing devices, and wherein the logic for selecting one of the plurality of pointing devices includes logic responsive to inputs from a graphical user interface for enabling the conversion of cursor movement commands associated with the selected pointing device into scrolling commands.
